(19) United States
(12) Patent Application Publication
(10) Pub. No.: US 2025/0205663 A1
(43) Pub. Date: Jun. 26, 2025

(54) MULTI-ALGORITHM CONTROL METHOD AND SYSTEM FOR TUB LEVEL IN FRACTURING BLENDER

(71) Applicant: STEWART & STEVENSON LLC, Houston, TX (US)

(72) Inventor: James RITTER, Houston, TX (US)

(21) Appl. No.: 18/946,638

(22) Filed: Nov. 13, 2024

Related U.S. Application Data
(60) Provisional application No. 63/614,255, filed on Dec. 22, 2023.

(51) Int. Cl. B01F 35/221; B01F 35/21; B01F 35/71; B01F 101/49

(52) U.S. Cl. CPC B01F 35/2212; B01F 35/2112; B01F 35/2113; B01F 35/2213; B01F 35/7176; B01F 35/718; B01F 2101/49

(57) ABSTRACT

A method includes supplying a blender tub and a suction pump, the suction pump connected to the blender tub through a tub inlet valve and measuring a suction pump pressure. The method also includes determining if the suction pump pressure is above or below a predetermined suction pump pressure. In addition, the method includes raising the suction pump pressure if the suction pump pressure is below the predetermined suction pump pressure setpoint or lowering the suction pump pressure if the suction pump pressure is above the predetermined suction pump pressure setpoint.

### CROSS-REFERENCE TO RELATED APPLICATIONS

This application is a nonprovisional application which claims priority from U.S. provisional application No. 63/614,255, filed Dec. 22, 2023, which is incorporated by reference herein in its entirety.

### TECHNICAL FIELD/FIELD OF THE DISCLOSURE

The present disclosure relates generally to well service equipment and specifically to equipment used with well fluids.

### BACKGROUND OF THE DISCLOSURE

During drilling, completion, and production operations, fluids are circulated through a wellbore. Various chemicals and materials are introduced into the fluids, referred to herein as the slurry, to produce slurries having desirable characteristics. Examples of chemicals and materials include dry proppants, such as sand, fluids, and gels. Slurries are traditionally formed in blender tubs.

The blenders of hydraulic fracturing systems have components to monitor the level of fluid within the blender tub. Conventionally, blender tubs may hold from 5 to 30 barrels (bbl) of proppant, slurry, or other liquids to support fracturing operations. The blender tub may discharge its contents at rates from 10 barrels per minute to over 300 barrels per minute.

Blender tub level may be conventionally controlled by monitoring tub level, as shown in FIGS. 1 and 2. Blender tub 100 includes tub level sensor 200 adapted to measure the level of the liquid in blender tub 100, shown as tub level 10 in FIG. 1. Tub level controller 400 compares tub level 10 with tub level setpoint 20. If the tub level 10 is below tub level setpoint 20, tub level controller 400 directs suction pump 350, connected to blender tub 100 through tub inlet 120, to increase pump rate to deliver more materials and chemicals for the slurry into blender tub 100 to achieve the tub level setpoint 20. Conversely, if tub level 10 is above the tub level setpoint 20, suction pump 350 slows its rate of pumping contents into blender tub 100.

### SUMMARY

A method of tub level control is disclosed. The method includes supplying a blender tub and a suction pump, the suction pump connected to the blender tub through a tub inlet valve and measuring a suction pump pressure. The method also includes determining if the suction pump pressure is above or below a predetermined suction pump pressure. In addition, the method includes raising the suction pump pressure if the suction pump pressure is below the predetermined suction pump pressure setpoint or lowering the suction pump pressure if the suction pump pressure is above the predetermined suction pump pressure setpoint.

A tub level control system is disclosed. The system includes a blender tub and a tub level sensor adapted to measure the level of liquid in the blender tub. The system also includes an inlet valve, the inlet valve in fluid communication with the blender tub and a suction pump, the suction pump in fluid communication with the blender tub through the inlet valve. Further, the system includes a suction pump pressure sensor adapted to measure the pressure of the suction pump and a controller, the controller in electrical connection with the suction pump pressure sensor and the tub level sensor.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a graphical depiction of a prior art tub level control scheme.

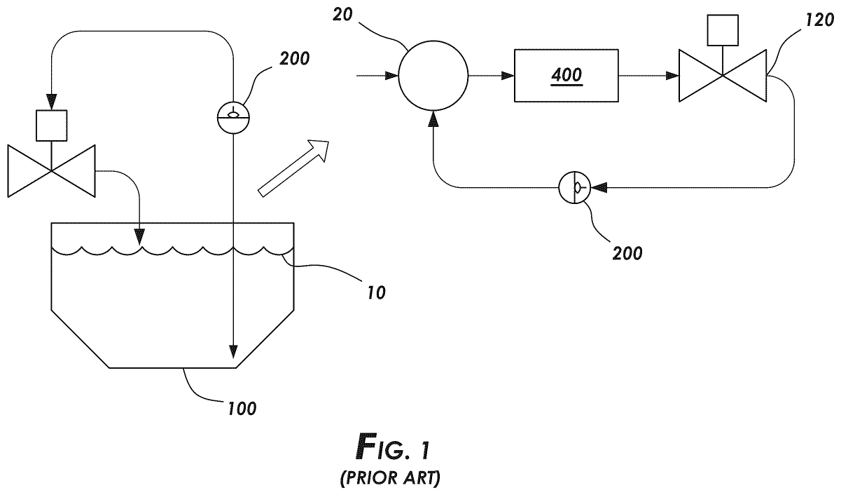

FIG. 2 is a graphical depiction of a prior art tub level control scheme.

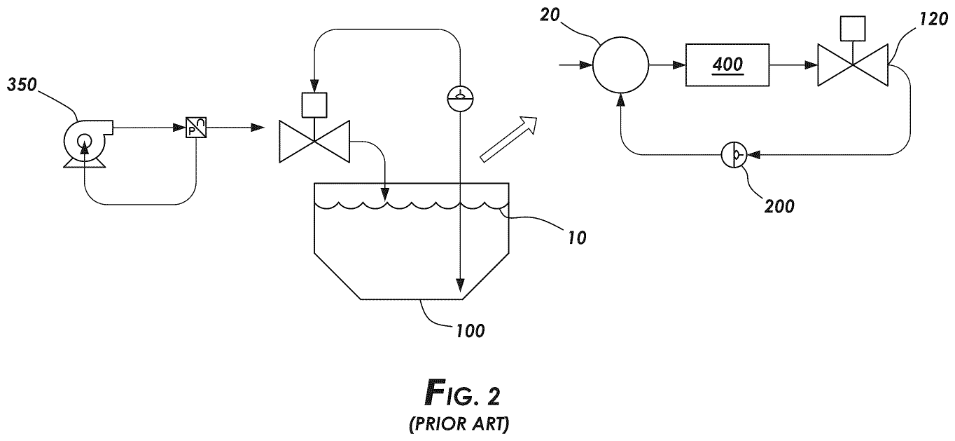

FIG. 3 is a graphical depiction of a tub level control scheme consistent with certain embodiments of the present disclosure.

FIG. 4 is a schematic depiction of a tub level control scheme consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

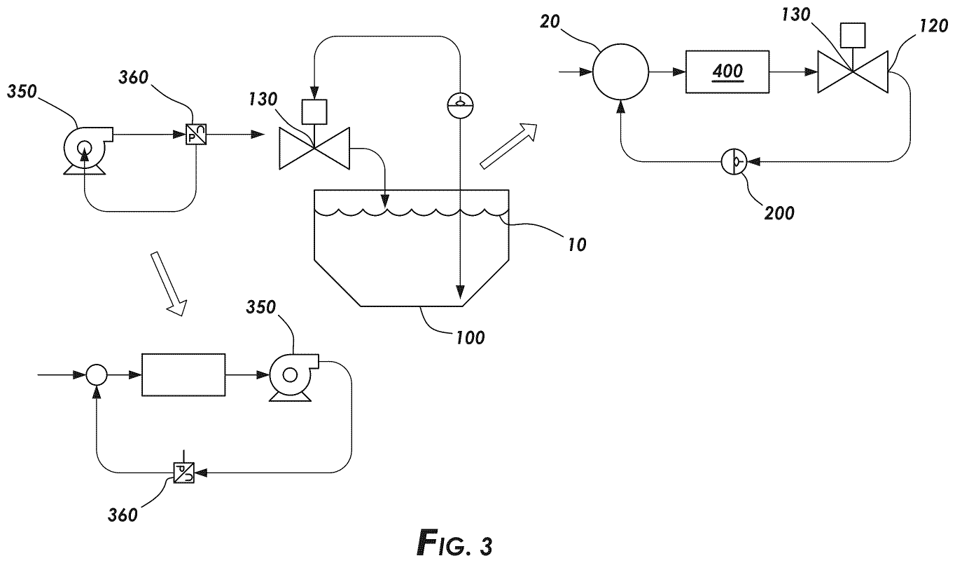

FIG. 3 is a graphical depiction of partial tub level control scheme 500 consistent with certain embodiments of the present disclosure. In addition to controlling pump rate, as described above, the present tub level control scheme includes two additional control loops: suction pump pressure and tub inlet valve.

In the current disclosure, as tub level 10 increases above tub level setpoint 20, inlet valve 130 may close to a percent open percentage of less than full open to maintain tub level set point 20. Further increases in tub level 10 above tub level setpoint 20 may result in additional further closure of inlet valve 130 potentially to fully closed. In a similar way, as tub level 10 falls below tub level set point 20, inlet valve 130 may open to a percentage less than full open to full open. By controlling with respect to inlet valve closed percentage instead of increasing or decreasing pump rate, gravity-fed water tanks upstream of blender tub 100 are prevented or retarded from continuing to flow into blender tub 100.

An additional point of control, operating in parallel but independently, may be suction pressure as shown in FIG. 3, based on a predetermined suction pressure setpoint. Suction pump pressure sensor 360 is in communication with suction pump 350 and inlet valve 130, adding an additional layer of control. Suction pressure may be measured by suction pump pressure sensor 360. Suction pump 350 may be set to operate at a predetermined suction pump pressure (e.g. 10 psi). If suction pump pressure sensor 360 indicates a suction pump pressure of less or more than the predetermined suction pump pressure, suction pump speed may increase or decrease respectively to increase or decrease the suction pump pressure. By keeping suction pressure constant, the controller will work for all ranges of the tub fill.

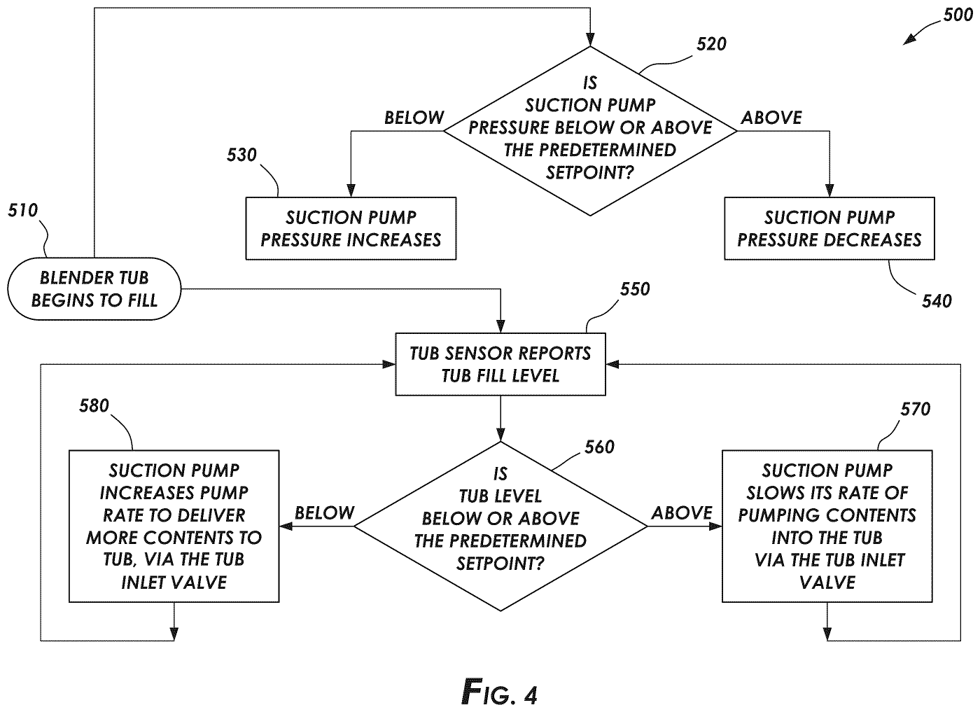

FIG. 4 further illustrates certain embodiments of the present disclosure, specifically tub level control scheme 500. As blender tub 100 begins to fill (510), suction pump pressure is measured by suction pump pressure sensor 360. Tub level controller 400 determines whether suction pump pressure is less than or more than a predetermined suction pressure setpoint (520). If less than the predetermined suction pump pressure setpoint, tub level controller 400 increases suction pump pressure (530). If more than the predetermined suction pump pressure setpoint, controller decreases suction pump pressure (540).

In addition, as shown in FIG. 4, as blender tub begins to fill (510), tub level sensor 200 measures tub level (550). Tub level sensor 200 is continuously monitored during operation of blender tub 100. Tub level controller 400 determines if tub level is above or below tub level setpoint (560). If tub level is above tub level setpoint, suction pump 350 slows the rate of pumping contents to blender tub 100 (570). If tub level is below tub level setpoint, suction pump 350 increases the rate of pumping contents to blender tub 100 (580).

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A method comprising of tub level control comprising:
supplying a blender tub and a suction pump, the suction pump connected to the blender tub through a tub inlet valve;
measuring a suction pump pressure;
determining if the suction pump pressure is above or below a predetermined suction pump pressure; and
raising the suction pump pressure if the suction pump pressure is below the predetermined suction pump pressure setpoint or lowering the suction pump pressure if the suction pump pressure is above the predetermined suction pump pressure setpoint.

2. The method of claim 1 further comprising:
measuring a tub fill level;
determining if the tub fill level is above or below a tub level setpoint; and
increasing a suction pump rate via the tub inlet valve if the tub fill level is below a tub level setpoint or slowing the suction pump rate via the tub inlet valve if the tub fill level is above a tub level setpoint.

3. A tub level control system comprising:
a blender tub;
a tub level sensor adapted to measure the level of liquid in the blender tub;
an inlet valve, the inlet valve in fluid communication with the blender tub;
a suction pump, the suction pump in fluid communication with the blender tub through the inlet valve;
a suction pump pressure sensor adapted to measure the pressure of the suction pump; and
a controller, the controller in electrical connection with the suction pump pressure sensor and the tub level sensor.

4. The system of claim 3 wherein the controller is adapted to:
measure a suction pump pressure;
determine if the suction pump pressure is above or below a predetermined suction pump pressure; and
raise the suction pump pressure if the suction pump pressure is below the predetermined suction pump pressure setpoint or lower the suction pump pressure if the suction pump pressure is above the predetermined suction pump pressure setpoint.

5. The system of claim 4, wherein the controller is adapted to:
measure a tub fill level;
determine if the tub fill level is above or below a tub level setpoint; and
increase a suction pump rate via the tub inlet valve if the tub fill level is below a tub level setpoint or slow the suction pump rate via the tub inlet valve if the tub fill level is above a tub level setpoint.
